(19) United States
(12) Patent Application Publication
(10) Pub. No.: US 2010/0325044 A1
(43) Pub. Date: Dec. 23, 2010

(54) System and Method for Accessing the Maximum Available Funds in an Electronic Financial Transaction

(76) Inventor: Sean MacGuire, Beaconsfield (CA)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(21) Appl. No.: 11/914,060

(22) PCT Filed: May 10, 2006
(86) PCT No.: PCT/US06/18034

§ 371 Date: Nov. 13, 2009

Related U.S. Application Data
(60) Provisional application No. 60/679,221, filed on May 10, 2005.

(51) Int. Cl. G06Q 40/00

(52) U.S. Cl. 705/42; 705/39; 705/44

(57) ABSTRACT

A “MAX”, or other appropriate descriptive, selection is added to the set of selections available to users of electronic financial transactions. This selection determines the maximum amount which can be accessed by a user, subject to hardware, software, account and other restrictions.

### CROSS REFERENCE TO RELATED APPLICATIONS

This Application is the U.S. National filing under §371 of International Application No. PCT/US2006/018034, with an international filing date of 10 May 2006, now pending, claiming priority from U.S. Provisional Application No. 60/679,221 filed 10 May 2005, and herein incorporated by reference.

### FIELD OF THE INVENTION

The present invention relates generally to the field of telecommunications and more specifically to a system and method for accessing funds in an electronic financial transaction.

### BACKGROUND OF THE INVENTION

With the introduction of financial tools like debit cards, smart cards and other “stored value” cards, consumers have more ways to access funds than ever before. Likewise, the number of systems which can use these devices, like ATMs, debit terminals, telephone IVR systems, and internet-based systems have likewise multiplied in number. One of the effects of this increase in electronic access cards and systems is a corresponding increase in electronic funds transactions.

This explosion of electronic funds transactions has in many cases made it very difficult for users to know precisely what balance is available for access from a given account using a given ATM card at any given time.

Therefore, a user of an ATM machine wishing to access the maximum amount of funds using a particular ATM card would likely require multiple transactions. This process is both time consuming and difficult, as repeated requests for small amounts would require possibly many transactions, each likely having their own service charge.

Repeated requests for larger amounts could result in system responses of “Insufficient Funds”. It is also possible that such repeated attempts at withdrawals in this manner would result in the bank believing that a user was involved in a pattern of fraud, when all they wanted to do was to get as much money out as possible, as quickly as possible.

Finally this process is sometimes embarrassing, since there are often other customers waiting in the ATM line behind the user, and users performing time-consuming, multiple trial-and-error transactions may not be looked upon kindly.

The problem is that there are a remarkable number of restrictions implicit in these transactions. These restrictions both affect and determine the maximum amount a user may be able to access using a given device at a given time beyond whether the user has the funds or available credit in their account.

For access cards, stored value cards and the like, financial institutions often place a withdrawal limit per card. Keeping track of how much money can still be withdrawn using a given ATM card or other access device with a daily and/or weekly limit is difficult. In addition, knowing on what days the weekly limit gets reset adds to the complexity of the problem. Even daily limits can be confounding, since a financial institution determines at what time their daily limit begins and ends, which may or may not correspond to midnight in the time zone the user happens to be located in.

Financial institutions may also place limits on what funds are available in any given account. They may restrict access to funds based on a number of criteria: from halting access to all or some transactions entirely, or holding funds for clearance, to a hybrid model such as only allowing the first $100 of a deposit by check to be withdrawn immediately. They may also impose arbitrary restrictions such as limiting access to funds during periods of banking system maintenance.

In addition, the electronic terminals themselves have certain limitations which must be taken into account. An ATM machine, for example, might only dispense $20 bills, whereby any withdrawal must be a multiple of $20. These devices also often have a maximum withdrawal amount, or a maximum number of bills can be dispensed in a single transaction. Finally an obvious limit to the available cash withdrawal is the amount of remaining cash in the ATM. Many of these restrictions are impossible for the customer to determine unassisted.

Sugimoto in U.S. Pat. No. 6,287,195 entitled “Game machine with bet number designating means” describes the “Maximum Bet” button available on many slot machines. Sugimoto teaches how the addition of a button which automatically determines the maximum bet in the game of chance increases the transaction speed, simplicity and convenience to the user.

Therefore a need has arisen for a system and method which eliminate or reduce the problems associated with known methods of obtaining the maximum amount of available funds in a single electronic financial transaction. Maximizing speed while simultaneously incurring the minimum amount of transaction fees saves time, money and embarrassment for the user.

### SUMMARY OF THE INVENTION

It is therefore an aim of the present invention to provide a novel method for allowing a user to access the maximum available funds from an electronic financial transaction.

Therefore, in accordance with the present invention, there is provided a method for providing maximum available funds to at least one user, the method comprising the steps of: a) having the user access a financial transaction system able to recognize the user and conduct financial transactions therewith; b) having the user request from said transaction system the amount of the maximum available funds available to the user; c) determining said maximum available funds; and d) providing said maximum available funds to the user.

Also in accordance with the present invention, there is provided a system for providing maximum available funds to a user upon a user's request therefor, comprising a financial transaction system capable of determining the maximum available funds that are available to the user and that can be provided thereto, said transaction system comprising a terminal and a communicating device for allowing said terminal to communicate with a financial institution, fund-providing means being provided for providing said maximum available funds to the user.

Further in accordance with the present invention, there is provided a computer implemented method for providing maximum available funds to at least one user, the method to be implemented over at least one communication network by a financial transaction system adapted for communicating over the network, said transaction system comprising at least one financial institution and at least one terminal, the method comprising the steps of: a) initiating at the terminal a request for the maximum available funds; b) establishing a communication link over the network between the terminal and the financial institution; c) determining said maximum available funds; and d) providing said maximum available funds to the user.

### BRIEF DESCRIPTION OF THE DRAWINGS

The features of the invention will become more apparent in the following detailed description in which reference is made to the appended drawings wherein:

FIG. 1 is a schematic representation showing the elements of a conventional electronic financial transaction system;

FIG. 2 is a flowchart showing the steps of a user performing an ATM transaction;

FIG. 3 is a schematic representation showing the amount selections on an electronic terminal in accordance with the present invention;

FIG. 4 is a flowchart showing how the Maximum transaction amount is determined from the financial institution, in accordance with the present invention; and

FIG. 5 is a flowchart showing how the Maximum transaction amount is affected by local device restrictions, in accordance with the present invention.

### DESCRIPTION OF ILLUSTRATIVE EMBODIMENTS OF THE INVENTION

Many electronic payment systems allow users to select a transaction amount from a group of predetermined selections. On an ATM machine or IVR system these selections might be identified as “$20”, “$40”, “$60”, “$80”, “$100”, etc. To choose an amount, the user simply indicates their selection by pressing the appropriate button, or touching the screen, or speaking the amount in an environment which uses voice recognition, etc.

The present invention creates a new selection: the MAX button. This selection automatically requests the maximum available amount for a given electronic financial transaction. This selection would typically be labeled “MAX” and be listed with other predetermined transaction amounts.

A user performing an electronic financial transaction, wishing to obtain the maximum amount for this transaction, selects the MAX button from a list of selections presented by the electronic financial transaction device. The maximum amount allowed for this transaction is then determined and requested based on the limits imposed by the requesting device, for example an ATM, the financial institution, as well as the funds and/or available credit of the user available at the time of the transaction.

It is noted that the transactions described herein may be performed via a telephone IVR system or over the Internet, but for this illustrative example, an electronic terminal such as an ATM machine will be used.

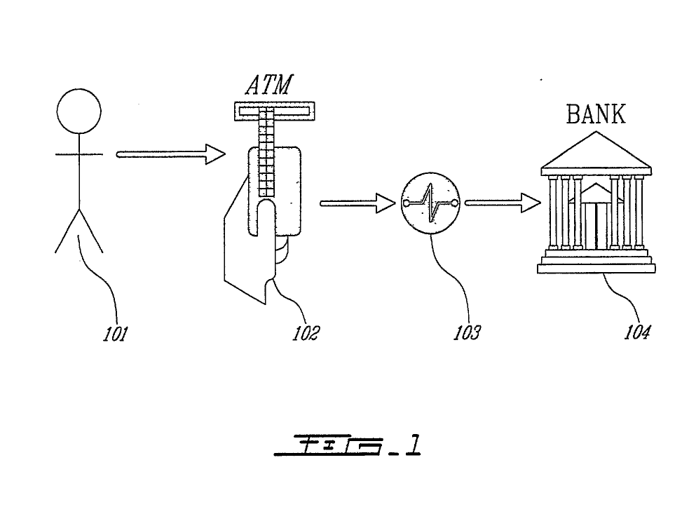

Referring therefore to FIG. 1, an electronic financial transaction system is generally comprised of a user 101, an electronic terminal 102, a network connection 103, and a financial institution 104. The user 101 interacts with the electronic terminal 102 to perform financial transactions which are transmitted to the financial institution 104 via the network connection 103.

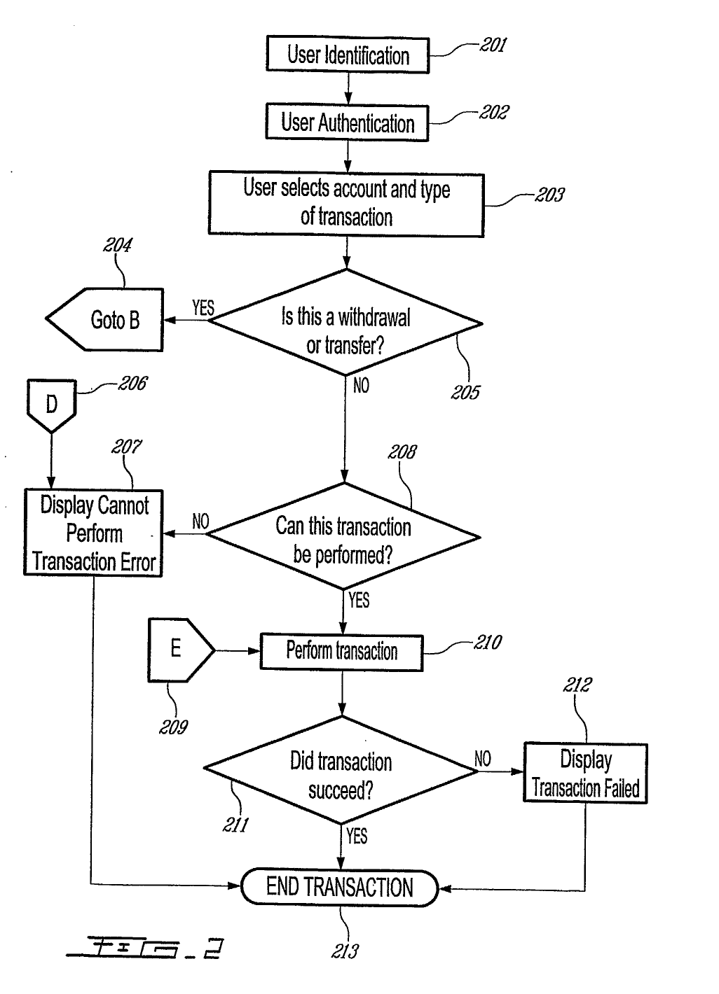

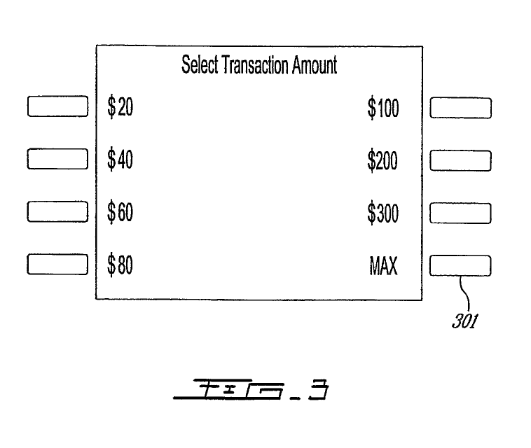

Turning to FIG. 2, the user 101 typically performs the identification step 201 by inserting a card or entering a user name. The user 101 then performs the authentication step 202 by entering a PIN number or a password or whatever the requirements of the financial system are. The user 101 indicates the nature of the transaction 203 he wishes to perform. If the transaction is a withdrawal or transfer of funds (see 205), the electronic terminal 102 presents the user 101 with a selection of amounts, for instance as shown in FIG. 3.

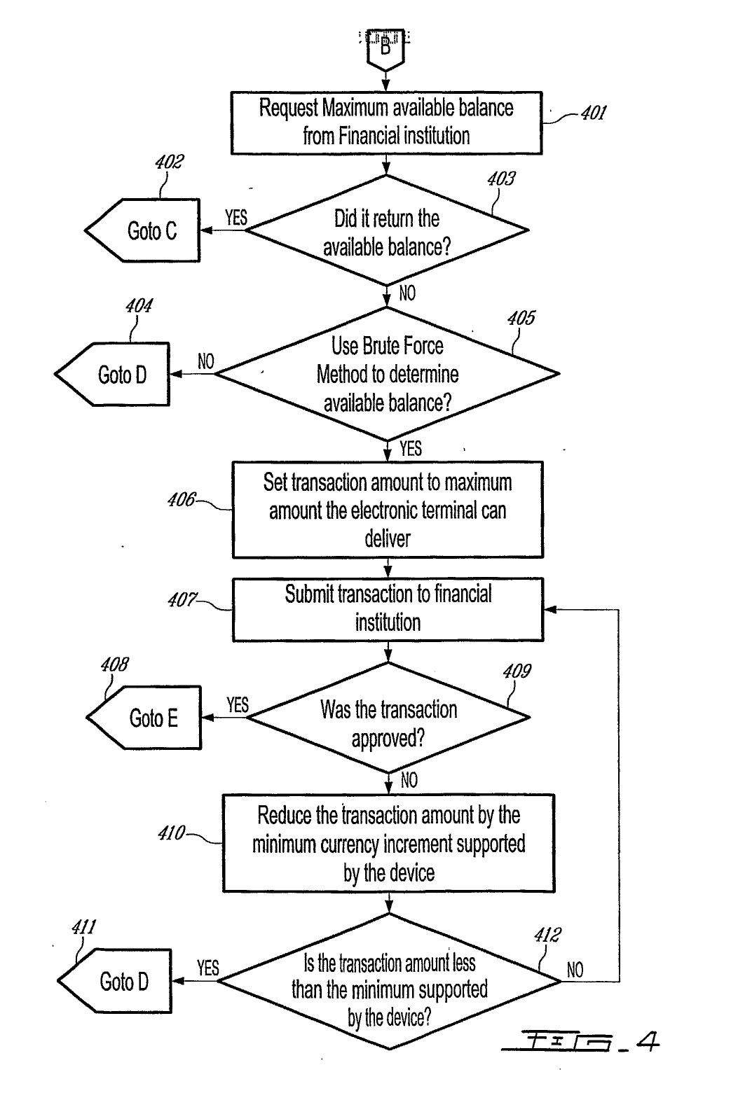

When, in accordance with the present invention, the MAX button 301 is pressed, the electronic terminal 102 requests the maximum transaction size from the financial institution 104 via the electronic network 103. The transaction then exits via point B (see 204 in FIG. 2) and goes to point B in FIG. 4 (see 400).

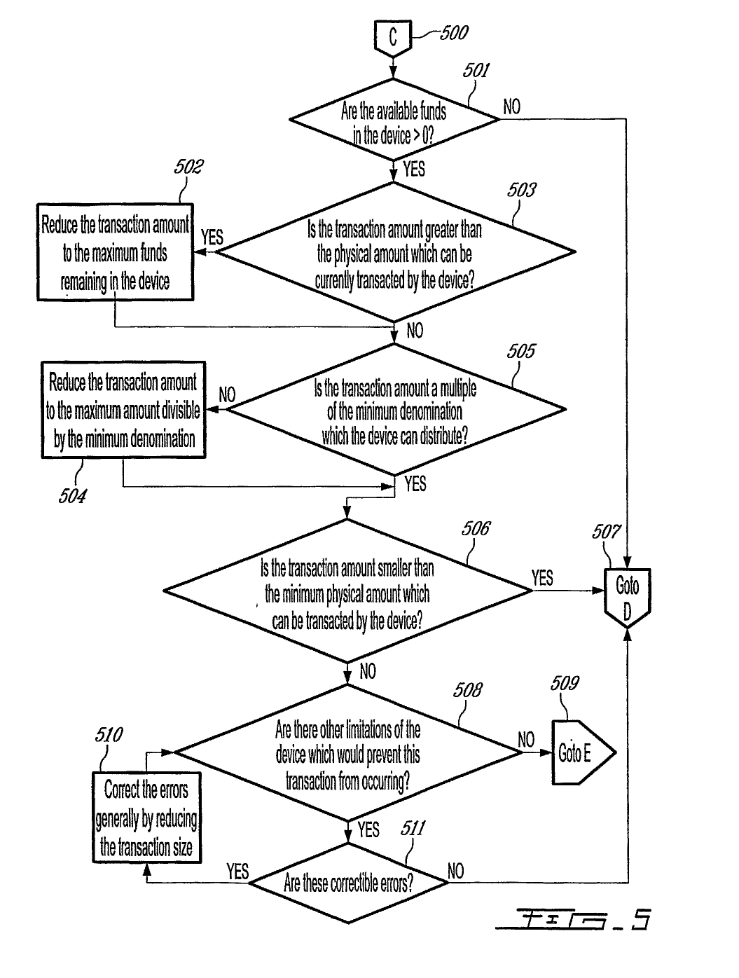

FIG. 4 shows the steps involved in determining the maximum available transaction size from the financial institution. This information must be available, by definition, from the bank so it can determine whether or not a user may perform the requested transfer or withdrawal of funds. First, the system requests the maximum available balance from Financial Institution 401. The system then checks at 403 if the bank has returned the available balance, and if so, the transaction leaves via point C 402 and goes to point C 500 in FIG. 5. If the bank does not return the available balance, the system decides at 405 whether to use a “brute force” method to determine the available balance. If the systems chooses not to use the brute force method at 405, the transaction exits via point D 404, and returns to point D 206 in FIG. 2, where there is displayed an error at 207 and the end of the transaction occurs at 213.

Under the brute force method, the system sets at 406 the transaction amount to the maximum transaction amount permitted by the client terminal, and then submits the transaction at 407 to the financial institution. The system then checks at 409 to see if the transaction has been approved. If it has, the transaction leaves at point E 408 and continues at point E 209 in FIG. 2.

If the transaction fails at 409, the system reduces at 410 the requested amount by the lowest currency increment supported by the device, and repeats the process until the transaction either succeeds or the amount trying to be requested is less than the minimum amount supported by the electronic terminal (see 412), at which point the transaction fails and goes to D 411 which returns it to point D 206 in FIG. 2, where there is displayed an error at 207 and the end of the transaction occurs at 213.

FIG. 5 shows how the financial terminal limits can be calculated and applied. First, the system checks at 501 to see if the available funds in the device are greater than 0. If there are no funds, the transaction exits via point D 507, and returns to D 206 in FIG. 2, where there is displayed an error at 207 and the end of the transaction occurs at 213.

The system next checks at 503 to see if the requested amount is greater than the amount which can be currently transacted by the device. If so, the system reduces at 502 the request to the maximum amount supported by the electronic terminal, and continues.

The system then has to make sure that this amount can be dispensed by the electronic terminal. The system thus checks at 505 to see if the transaction amount is a multiple of the minimum currency denomination which the device can distribute. If it is not, the system reduces at 504 the transaction amount to the maximum amount divisible by the minimum denomination, and continues.

The system then checks at 506 if the resulting amount is smaller than the minimum physical amount which may be transacted by the device, and if it is, the transaction fails by going to point D 507 and returning to D 206 in FIG. 2, where there is displayed an error at 207 and the end of the transaction occurs at 213.

Finally, the transaction hits the ‘catch all’ clause checks at 508 as to whether or not there are other limitations of the device which would prevent this transaction from occurring, such as various and sundry limitations on the number and types of currency that can be dispensed, etc. If there are, the system then asks at 511 if there are correctable errors. If the errors are correctable, the system does so at 510 (generally by reducing the size of the requested amount), and repeats the process until there are no more correctable errors left. If there are errors that cannot be corrected, the transaction again exits via point D 507 and returns to D 206 on FIG. 2, where there is displayed an error at 207 and the end of the transaction occurs at 213.

Otherwise, the system proceeds with the transaction via point E 509 which brings the transaction back to E 209 in FIG. 2, where the system actually performs the transaction 211. If the transaction fails, the system displays at 212 “Transaction Failed”, and ends the transaction at 213. If the transaction succeeds, the system just ends the transaction at 213.

Although the invention has been described with reference to certain specific embodiments, various modifications thereof will be apparent to those skilled in the art without departing from the spirit and scope of the invention. The entire disclosures of all references recited above are incorporated herein by reference.

What is claimed is:

1. A method for providing maximum available funds to at least one user, the method comprising the steps of:
a) having the user access a financial transaction system able to recognize the user and conduct financial transactions therewith;
b) having the user request from said transaction system the amount of the maximum available funds available to the user;
c) determining said maximum available funds; and
d) providing said maximum available funds to the user.

2. A method as defined in claim 1, wherein said maximum available funds provided to the user in step d) include cash.

3. A method as defined in claim 1, wherein said maximum available funds provided to the user in step d) are cash.

4. A method as defined in claim 1, wherein the user has at least one account at said financial transaction system.

5. A method as defined in claim 1, wherein the user has at least one account at said financial transaction system and wherein said financial transaction system comprises a bank.

6. A method as defined in claim 1, wherein the user has at least one account at said financial transaction system and wherein said financial transaction system comprises a credit card institution.

7. A method as defined in claim 1, wherein in step d), said maximum available funds are provided to the user in the form of a cash withdrawal.

8. A method as defined in claim 1, wherein in step d), said maximum available funds are provided to the user in the form of a fund transfer.

9. A method as defined in claim 1, wherein in step b), the user requests the amount of the maximum available funds available to the user by pressing a single key on a transaction amount menu of an electronic terminal of said financial transaction system.

10. A method as defined in claim 1, wherein in step c), said transaction system after having determined said maximum available funds, informs the user of said maximum available funds.

11. A method as defined in claim 1, wherein in step c), said maximum available funds are determined by a financial institution that is part of said transaction system.

12. A method as defined in claim 1, wherein in step d), said maximum available funds are provided to the user in the form of a cash withdrawal, wherein said transaction system comprises a financial institution and an electronic terminal, and wherein in step c), if said maximum available funds cannot be provided to said electronic terminal by said financial institution, a maximum terminal amount that be delivered by said electronic terminal is submitted to said financial institution, whereby if said maximum terminal amount is approved by said financial institution, said maximum terminal amount constitutes said maximum available funds then remitted in step d) to the user in the form of cash, whereas if said maximum terminal amount is not approved by said financial institution, said maximum terminal amount is reduced by a minimum currency increment supported by said electronic terminal to provide a transaction amount then submitted for approval to said financial institution with such a reduction in the transaction amount being repeated until it is approved by said financial institution whereat said so-approved transaction amount constitutes said maximum available funds then remitted in step d) to the user in the form of cash.

13. A method as defined in claim 12, wherein in step c), if the so-approved transaction amount is lower than a minimum supported by said electronic terminal, no funds are remitted to the user.

14. A method as defined in claim 11, wherein determination by said financial institution in step c) of said maximum available funds takes into consideration (i) an account balance, (ii) whether available funds in the account are greater than a physical amount which can be dispensed by said electronic terminal; and (iii) whether available funds in the account are less than a physical amount which can be dispensed by said electronic terminal; said maximum available funds being possibly adjusted so as to be a multiple of the minimum denomination that can be dispensed by said electronic terminal.

15. A system for providing maximum available funds to a user upon a user's request therefor, comprising a financial transaction system capable of determining the maximum available funds that are available to the user and that can be provided thereto, said transaction system comprising a terminal and a communicating device for allowing said terminal to communicate with a financial institution, fund-providing means being provided for providing said maximum available funds to the user.

16. A system as defined in claim 15, wherein said maximum available funds provided to the user by said fund-providing means include cash.

17. A system as defined in claim 15, wherein said maximum available funds provided to the user by said fund-providing means are cash.

18. A system as defined in claim 15, wherein the user has at least one account at said financial transaction system.

19. A system as defined in claim 15, wherein the user has at least one account at said financial institution and wherein said financial institution comprises a bank.

20. A system as defined in claim 15, wherein the user has at least one account at said financial institution and wherein said financial institution comprises a credit card service.

21. A system as defined in claim 15, wherein said maximum available funds are provided by said fund-providing means to the user in the form of a cash withdrawal.

22. A system as defined in claim 15, wherein said maximum available funds are provided by said fund-providing means to the user in the form of a fund transfer.

23. A system as defined in claim 15, wherein said terminal includes a key on a transaction amount menu thereof, said key being associated with a request for the amount of the maximum available funds available to the user, wherein activation of said key by the user initiates the request to said transaction system of determining and providing to the user said maximum available funds.

24. A system as defined in claim 15, wherein when the amount of said maximum available funds for a cash withdrawal is determined by said financial institution, said financial institution, to determine said maximum available funds, takes into consideration: (i) an account balance at said financial institution, (ii) whether available funds in the account are greater than a physical amount which can be dispensed by said terminal; and (iii) whether available funds in the account are less than a physical amount which can be dispensed by said terminal; transaction system being adapted to adjust said maximum available funds so as to be a multiple of the minimum denomination that can be dispensed by said terminal.

25. A computer implemented method for providing maximum available funds to at least one user, the method to be implemented over at least one communication network by a financial transaction system adapted for communicating over the network, said transaction system comprising at least one financial institution and at least one terminal, the method comprising the steps of:
a) initiating at the terminal a request for the maximum available funds;
b) establishing a communication link over the network between the terminal and the financial institution;
c) determining said maximum available funds; and
d) providing said maximum available funds to the user.

26. A method as defined in claim 25, wherein said maximum available funds provided to the user in step d) include cash.

27. A method as defined in claim 25, wherein said maximum available funds provided to the user in step d) are cash.

28. A method as defined in claim 25, wherein the user has at least one account at said financial institution.

29. A method as defined in claim 25, wherein the user has at least one account at said financial institution and wherein said financial transaction system comprises a bank.

30. A method as defined in claim 25, wherein the user has at least one account at said financial institution and wherein said financial institution comprises a credit card institution.

31. A method as defined in claim 25, wherein in step d), said maximum available funds are provided to the user in the form of a cash withdrawal.

32. A method as defined in claim 25, wherein in step d), said maximum available funds are provided to the user in the form of a fund transfer

33. A method as defined in claim 25, wherein in step a), the user requests the amount of the maximum available funds available to the user by pressing a single key on a transaction amount menu of the terminal.

34. A method as defined in claim 25, wherein in step c), said transaction system after having determined said maximum available funds, informs the user of said maximum available funds.

35. A method as defined in claim 25, wherein in step c), said maximum available funds are determined by the financial institution.

36. A method as defined in claim 25, wherein in step d), said maximum available funds are provided to the user in the form of a cash withdrawal, and wherein in step c), if said maximum available funds cannot be provided to said terminal by said financial institution, a maximum terminal amount that be delivered by said terminal is submitted to said financial institution, whereby if said maximum terminal amount is approved by said financial institution, said maximum terminal amount constitutes said maximum available funds then remitted in step d) to the user in the form of cash, whereas if said maximum terminal amount is not approved by said financial institution, said maximum terminal amount is reduced by a minimum currency increment supported by said terminal to provide a transaction amount then submitted for approval to said financial institution with such a reduction in the transaction amount being repeated until it is approved by said financial institution whereat said so-approved transaction amount constitutes said maximum available funds then remitted in step d) to the user in the form of cash.

37. A method as defined in claim 36, wherein in step c), if the so-approved transaction amount is lower than a minimum supported by said terminal, no funds are remitted to the user.

38. A method as defined in claim 35, wherein determination by said financial institution in step c) of said maximum available funds takes into consideration (i) an account balance, (ii) whether available funds in the account are greater than a physical amount which can be dispensed by said terminal; and (iii) whether available funds in the account are less than a physical amount which can be dispensed by said terminal; said maximum available funds being possibly adjusted so as to be a multiple of the minimum denomination that can be dispensed by said terminal.
